(19) United States
(12) Patent Application Publication
(10) Pub. No.: US 2026/0170191 A1
(43) Pub. Date: Jun. 18, 2026

(54) METHOD AND APPARATUS FOR ANALYZING NOISE/VIBRATION TRANSFER PATH

(71) Applicants: HYUNDAI MOTOR COMPANY, Seoul (KR); Kia Corporation, Seoul (KR)

(72) Inventors: Moonseok LEE, Hwaseong-si (KR); Chisung OH, Hwaseong-si (KR)

(21) Appl. No.: 19/230,509

(22) Filed: Jun. 6, 2025

(30) Foreign Application Priority Data
Dec. 13, 2024 (KR) 10-2024-0185583

(51) Int. Cl. G06F 30/15; G01H 17/00; G06F 119/10

(52) U.S. Cl. CPC G06F 30/15; G01H 17/00; G06F 2119/10

(57) ABSTRACT

A noise/vibration transfer path analysis apparatus for analyzing contribution of a transfer path of noise/vibration in a vehicle includes an acoustic transfer function storage, an adaptive filter, and a path contribution analysis unit. The acoustic transfer function storage stores a plurality of acoustic transfer functions including a first acoustic transfer function and a second acoustic transfer function. The adaptive filter generates a first noise prevention signal based on a first reference signal output and a first adaptive transfer characteristic coefficient and generates a second noise prevention signal based on a second reference signal output and a second adaptive transfer characteristic coefficient. The path contribution analysis unit analyzes contribution of a noise transfer path in a target microphone for each of the first and second reference signals based on an updated first and second adaptive filter coefficients and the first and second acoustic transfer functions.

### CROSS-REFERENCE TO RELATED APPLICATION

This application claims priority to and the benefit of Korean Patent Application No. 10-2024-0185583 filed with the Korean Intellectual Property Office on Dec. 13, 2024, the entire contents of which are incorporated herein by reference.

### TECHNICAL FIELD

The present disclosure relates to a method and apparatus for analyzing a noise/vibration transfer path, and in particular, to a method and system for analyzing contribution of a noise/vibration transfer path by identifying a main transfer path of noise or vibration generated by a noise/vibration source and transferred through various paths through an active noise cancelling (hereinafter referred to as “ANC”) algorithm.

### BACKGROUND

Transfer path analysis (hereinafter referred to as “TPA”), based on physical theory or signal correlation, is primarily used to identify the causes of noise or vibration issues in vehicles. Originally developed as a signal processing method for multiple-input, multiple-output systems, TPA is well-suited for analyzing individual transfer path contributions and diagnosing problem sources. However, TPA technology presents challenges, including the difficulty of measuring input load and volume velocity, the primary causes of noise and vibration, and the complexity of testing, which requires significant time and manpower.

To address these limitations, operational TPA (hereinafter referred to as “OTPA”) was developed. OTPA simplifies transfer path analysis by computing transfer functions based on correlations between input signal and output signals. However, due to its lack of physical causality, OTPA struggles to predict noise accurately when system conditions change.

More recently, artificial intelligence (AI)-based methods have emerged for noise and vibration prediction. For example, conventional AI-based techniques utilize deep learning models to quickly and accurately assess how vibrations from various vehicle components contribute to indoor noise.

However, while AI methods may predict output noise or vibration from input signals, they provide limited insight into the quantitative contribution of each input due to complex interconnections between input signals and outputs across model layers. As a result, similar to OTPA, AI-based approaches allow for noise prediction but face challenges in diagnosing the root causes of noise vulnerabilities due to a lack of physical causality.

### SUMMARY

The present disclosure is directed to a method and system for analyzing a noise/vibration transfer path that secures physical causality and facilitates test evaluation.

According to one aspect of the subject matter described in this application, a noise/vibration transfer path analysis apparatus for analyzing contribution of a transfer path of noise or vibration in a vehicle comprising a plurality of sensors, a plurality of input exciters, and a target microphone, can include: an acoustic transfer function storage configured to store a plurality of acoustic transfer functions including (i) a first acoustic transfer function between a first input exciter of the plurality of input exciters and the target microphone and (ii) a second acoustic transfer function between a second input exciter of the plurality of input exciters and the target microphone; an adaptive filter configured to generate a first noise prevention signal based on a first reference signal output from a first sensor of the plurality of sensors and a first adaptive transfer characteristic coefficient and output the generated first noise prevention signal to the first input exciter, and generate a second noise prevention signal based on a second reference signal output from a second sensor of the plurality of sensors and a second adaptive transfer characteristic coefficient and output the generated second noise prevention signal to the second input exciter; an adaptive filter controller configured to update the first and second adaptive transfer characteristic coefficients based on an error signal output from the target microphone; and a path contribution analysis unit, implemented using one or more computing devices, configured to, based on the updated first and second adaptive filter coefficients and the first and second acoustic transfer functions stored in the acoustic transfer function storage unit, contribution of a noise transfer path in the target microphone for each of the first and second reference signals.

In some implementations, the first sensor can be a vibration sensor or a reference microphone.

In some examples, the noise/vibration transfer path analysis apparatus can further include a path filter configured to filter (i) the first reference signal with a modeled first acoustic transfer function corresponding to the first acoustic transfer function and (ii) the second reference signal with a modeled second acoustic transfer function corresponding to the second acoustic transfer function.

In some implementations, the adaptive filter controller can be configured to update the first and second adaptive transfer characteristic coefficients in a direction that reduces a size of the error signal based on the first reference signal filtered by the modeled first acoustic transfer function, the second reference signal filtered by the modeled second acoustic transfer function, and the error signal.

In some examples, the first sensor and the second sensor can match one-to-one the first input exciter and the second input exciter, respectively, and the contribution of the noise transfer path in the target microphone generated by the first reference signal can be determined based on a product of the first adaptive filter coefficient and the first acoustic transfer function, and the contribution of the noise transfer path in the target microphone generated by the second reference signal can be determined based on a product of the second adaptive filter coefficient and the second acoustic transfer function.

According to another aspect of the subject matter described in this application, a noise/vibration transfer path analysis method for analyzing contribution of a transfer path of noise/vibration in a vehicle comprising a plurality of sensors, a plurality of input exciters, and a target microphone, can include: associating a first reference signal output from a first sensor of the plurality of sensors with a first input exciter of the plurality of input exciters, and a second reference signal output from a second sensor of the plurality of sensors to a second input exciter of the plurality of exciters; measuring and storing a plurality of acoustic transfer functions including a first acoustic transfer function between the first input exciter and the target microphone and a second acoustic transfer function between the second input exciter and the target microphone; a updating first and second adaptive transfer characteristics coefficients applied to the first and second input exciters respectively with an active noise removal (ANC) algorithm; and analyzing, based on the updated first and second adaptive filter coefficients and the stored first and second acoustic transfer functions, contribution of a noise transfer path in the target microphone for each of the first and second reference signals.

In some implementations, updating first and second adaptive transfer characteristics coefficients can include generating a first noise prevention signal based on a first reference signal output from the first sensor and the first adaptive transfer characteristic coefficient and outputting the generated first noise prevention signal to the first input exciter; generating a second noise prevention signal based on a second reference signal output from the second sensor and the second adaptive transfer characteristic coefficient and outputting the generated second noise prevention signal to the second input exciter; and updating the first and second adaptive transfer characteristic coefficients based on an error signal output from the target microphone.

In some examples, updating first and second adaptive transfer characteristics coefficients can include: filtering the first reference signal with a modeled first acoustic transfer function corresponding to the first acoustic transfer function; and filtering the second reference signal with a modeled second acoustic transfer function corresponding to the second acoustic transfer function.

In some examples, updating first and second adaptive transfer characteristics coefficients can include updating the first and second adaptive transfer characteristic coefficients in a direction that minimizes a size of the error signal based on a first reference signal filtered by the modeled first acoustic transfer function, a second reference signal filtered by the modeled second acoustic transfer function, and the error signal.

According to another aspect of the subject matter described in this application, a computer can include at least one memory storing instructions and at least one processor configured to execute the instructions to perform operations. The operations can include storing a plurality of acoustic transfer functions including a first acoustic transfer function between a first input exciter provided and a target microphone provided in a vehicle, and a second acoustic transfer function between a second input exciter provided in the vehicle and the target microphone, updating first and second adaptive transfer characteristics coefficients applied to the first and second input exciters respectively with an active noise removal (ANC) algorithm, and analyzing, based on the updated first and second adaptive filter coefficients and the stored first and second acoustic transfer functions, contribution of a noise transfer path in the target microphone for each of first and second reference signals, the first and second reference signals being respectively output from the first and second sensors provided in the vehicle.

According to implementations of these features, the contribution of the noise transmission path can be efficiently analyzed by connecting the transmission path input signal to the input exciter one-to-one to match the noise/vibration transmission path, and then recognizing the main transmission path through the active noise removal (ANC) algorithm for noise or vibration generated by noise/vibration sources and transmitted through various paths.

### BRIEF DESCRIPTION OF THE DRAWINGS

FIG. 1 is a diagram illustrating an example of an apparatus for analyzing a noise/vibration transfer path.

FIG. 2 is a diagram schematically illustrating an example of a noise/vibration transfer path.

FIG. 3 is a diagram illustrating an example of the noise/vibration transfer path.

FIG. 4 is a flowchart illustrating an example of a method of analyzing a noise/vibration transfer path.

FIGS. 5 and 6 are diagrams illustrating an example of a tire emission noise transfer path analysis case to which the noise/vibration transfer path analysis method is applied.

FIGS. 7, 8A, and 8B are diagrams illustrating an example of a high-frequency noise transfer path analysis of a rear seat indoor luggage to which the noise/vibration transfer path analysis method is applied.

FIG. 9 is a diagram illustrating an example of a computer device.

### DETAILED DESCRIPTION

An exemplary implementation of the present disclosure describes a noise/vibration transfer path analysis method that effectively recognizes a main transfer path for noise or vibration generated by noise/vibration sources and transmitted through various paths through an active noise removal (ANC) algorithm.

ANC technology mitigates ambient noise using active elements, such as microphones, to offset or control noise levels. A conventional ANC system includes a reference microphone (or vibration sensor), a noise control speaker (or vibration control exciter), a target microphone (error microphone), and an active noise controller.

In an ANC system, the reference microphone (or vibration sensor) detects noise (or vibration) before it is controlled, while the noise control speaker (or vibration control exciter) generates a counteracting signal to suppress the noise (or vibration) control. The target microphone then measures the effectiveness of the noise control (or vibration) control. The active noise controller processes signals from the reference and target microphones, applies an algorithm to generate a noise control signal, and outputs the signal to the noise control speaker (or vibration control exciter). Hereinafter, the term “input exciter” can refer to both the noise control speaker and the vibration control exciter.

In the exemplary implementation of the present disclosure, the noise/vibration transfer path can be analyzed by using the filtered-X Last Mean Square (LMS) ANC algorithm as the ANC algorithm.

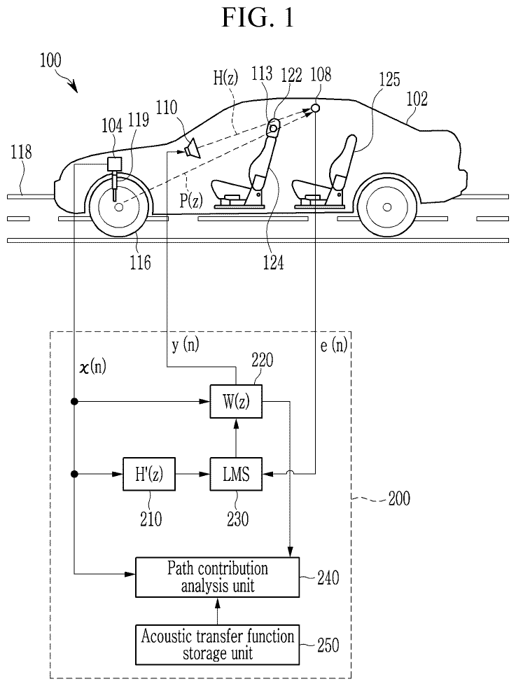

FIG. 1 is a diagram illustrating an example of an apparatus for analyzing a noise/vibration transfer path.

Referring to FIG. 1, a noise/vibration transfer path analysis apparatus 200 can transform and use an active noise removal (ANC) system that generates noise prevention by adaptively filtering a signal from a vibration sensor 104 and by using a microphone 108 (hereinafter, referred to as a “target microphone”) that is installed in the vehicle 100 and measures one or more noise control results.

In FIG. 1, a noise prevention signal y(n) output from the noise/vibration transfer path analysis apparatus 200 can be reproduced through one or more input exciters 110 to be a sound (hereinafter, referred to as a “noise prevention sound”). For example, the noise prevention signal y(n) is ideally controlled so that the noise prevention sound reproduced through the input exciter 110 and transmitted near the target microphone 108 is substantially opposite to the road noise heard by the occupant in the target microphone 108 and has the same magnitude.

For simplicity, FIG. 1 illustrates that a single vibration sensor 104 or target microphone 108, and input exciter 110 are implemented in the vehicle 100, but a plurality of vibration sensors 104, reference speakers, target microphones 108, and input exciters 110 can be implemented in the actual vehicle.

One or more vibration sensors 104, mechanically coupled to a suspension device 119 or a chassis 102 of the vehicle, can sense noise and vibration generated from a wheel 116 moving on the road surface. The vibration sensor 104 can output a reference signal x(n) that is a vibration signal indicating the detected road surface vibration. In some implementations, a reference microphone can be installed instead of a vibration sensor to output a reference signal indicating noise generated from the interaction between the wheel 116 and the road surface 118.

In some implementations, the reference signal x(n) can refer to a signal at a point associated with the noise transfer path, for example, a signal sound near the front and rear tires, a proximity sound for each luggage part, and the like.

In some implementations, one input exciter 110 corresponds with one vibration sensor (or reference microphone) one-to-one. In FIG. 1, the input exciter 110 can correspond to an actual input point of a reference signal output by a matching vibration sensor (or reference microphone).

The road surface noise (reference signal) generated from the interaction of the wheel 116 and the road surface 118 can be mechanically or acoustically transmitted to the cabin in the vehicle through the input exciter 110 and received by one or more target microphones 108 within the vehicle. One or more target microphones 108 can be provided, for example, in a headliner or other suitable location of the vehicle 100 to detect noise from an occupant inside the vehicle, such as an occupant sitting in a rear seat 125.

In FIG. 1, H(z) can refer to an acoustic transfer function (hereinafter, referred to as an “AFC”) between the input exciter 110 and the target microphone 108. The acoustic transfer function can be determined based on a distance between the input exciter and the target microphone, performance of the speaker, and the like. Although only one acoustic transfer function is illustrated in FIG. 1, a plurality of acoustic transfer functions can be provided between a plurality of input exciters 110 and one or more target microphones 108.

These acoustic transfer functions (i.e., the acoustic transfer function between a specific input exciter and a specific target microphone) can be measured in advance and stored in an acoustic transfer function storage unit 250 of the noise/vibration transfer path analysis apparatus 200.

In FIG. 1, the road noise generated from the interaction of the road surface 118 and the wheel 116 can be transferred to the target microphone 108 according to a transfer characteristic P(z), which represents the characteristic of the primary path (i.e., the acoustic transfer function between the actual noise source and the target microphone).

The target microphone 108 can output an error signal e(n) corresponding to a difference between noise existing in the vehicle interior based on road surface noise and a noise prevention sound for preventing noise reproduced through the input exciters 110.

The noise/vibration transfer path analysis apparatus 200 can receive a plurality of reference signals x(n) transmitted from the plurality of vibration sensors 104 or the reference speaker and an error signal e(n) output from the target microphone 108, generate a plurality of noise prevention signals y(n) that minimize the error signal e(n) by applying the ANC algorithm, and output the generated plurality of noise prevention signals y(n) to the plurality of input exciters 110, respectively. Accordingly, the noise/vibration transfer path analysis apparatus 200 can analyze the contribution of the noise transfer path by recognizing the main transfer path of noise or vibration generated by the noise/vibration source and transferred through various paths through the ANC algorithm.

It is schematically illustrated that the ANC system, the simplified noise/vibration transfer path analysis apparatus 200 illustrated in FIG. 1, is applied to a vehicle having one secondary path (acoustic transfer function) expressed as H(z) between the input exciter 110 and the target microphone 108, but the noise/vibration transfer path analysis apparatus 200 can be applied to a vehicle in which multiple input exciters, one or more target microphones, and multiple vibration sensors (or reference microphones) are installed and has a plurality of acoustic transfer functions.

The noise/vibration transfer path analysis apparatus 200 can include a path filter 210, an adaptive filter 220, an adaptive filter controller 230, a path contribution analysis unit 240, and the acoustic transfer function storage unit 250.

The acoustic path function storage unit 250 can store a plurality of acoustic transfer functions measured in advance between the plurality of input exciters 110 and one or more target microphones 108. For example, the acoustic path function storage unit 250 can store a plurality of acoustic transfer functions including a first acoustic transfer function between a first input exciter and the target microphone 108 and a second acoustic transfer function between a second input exciter and the target microphone 108.

The path filter 210 can filter a plurality of reference signals x(n) output from the vibration sensor 104 at a point associated with the noise transfer path or the reference speaker by using a plurality of modeled acoustic transfer functions H′(z) that estimate characteristics of a path (i.e., a secondary path) between the input exciter 110 and the target microphone 108. For example, the path filter 210 can filter a first reference signal output from a first vibration sensor by using a modeled first acoustic transfer function corresponding to the first acoustic transfer function, and filter a second reference signal output from a second vibration sensor by using a modeled second acoustic transfer function corresponding to the second acoustic transfer function.

The adaptive filter 220 can generate a plurality of noise prevention signals y(n) based on a combination of a plurality of adaptive transfer characteristic coefficients W(z) and a plurality of reference signals x(n), and output the generated plurality of noise prevention signals y(n) to the corresponding input exciters 110. casein some implementations, the adaptive transfer characteristic coefficient W(z) of the adaptive filter 220 can be updated by the adaptive filter controller 230. For example, the adaptive filter 220 can generate a first noise prevention signal based on the first reference signal output from the first vibration sensor and a first adaptive transfer characteristic coefficient and output the generated first noise prevention signal to the first input exciter, and generate a second noise prevention signal based on the second reference signal output from the second vibration sensor and a second adaptive transfer characteristic coefficient and output the generated second noise prevention signal to the second input exciter.

The adaptive filter controller 230 can operate according to a filtered-x least mean square (FxLMS) algorithm that updates a plurality of transfer characteristic coefficients W(z) in a direction of minimizing the magnitude of the error signal e(n) based on a plurality of reference signals X(n) filtered by a plurality of acoustic transfer functions H′(z) modeled by the path filter 210, respectively, and the error signal e(n) output from the target microphone. For example, the adaptive filter controller 230 can update the first and second adaptive transfer characteristic coefficients in a direction that minimizes the magnitude of the error signal based on the first reference signal filtered by the modeled first acoustic transfer function, the second reference signal filtered by the modeled second acoustic transfer function, and the error signal. In some implementations, the FxLMS algorithm was described as an example as the LMS algorithm, but the present disclosure is not limited to the FxLMS algorithm, and various other ANC algorithms can be used.

The noise prevention sound output from each input exciter 110 can be combined with road noise in a vehicle cabin near the target microphone 108 to reduce a road noise-induced sound pressure level SPL at this location.

The path contribution analysis unit 240 can analyze the contribution of the noise transfer path generated by a plurality of noise/vibration sources based on the updated transfer characteristic coefficient W(z) and a plurality of acoustic transfer functions stored in the acoustic path function storage unit 250. For example, the path contribution analysis unit 240 can analyze the contribution of the noise transfer path at the target microphone generated by the first and second reference signals based on the updated first and second adaptive filter coefficients and the first and second acoustic transfer functions stored in the acoustic transfer function storage unit.

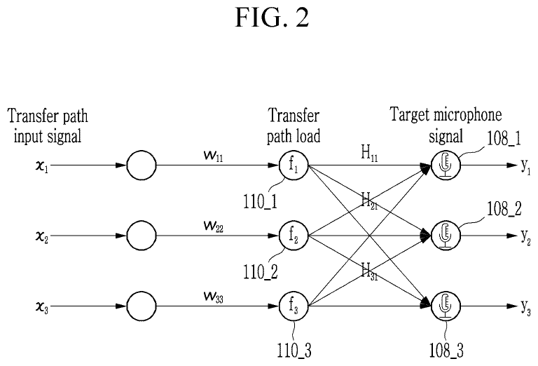

FIG. 2 is a diagram schematically illustrating an example of the noise/vibration transfer path.

Referring to FIG. 2, multiple reference signals x1, x2, and x3 can be received while driving are signals generated by corresponding vibration excitation sources (vibration sensors) or noise excitation sources (noise speakers), respectively, and can refer to signals at points associated with noise transfer paths (e.g., signal sounds near front and rear tires, or proximity sounds by luggage area).

Referring to FIG. 2, in some implementations, the reference signals x1, x2, and x3 are connected one to one to the input exciters 110_1, 110_2, and 110_3, which are corresponding transfer path loads, so that they are physically causal, i.e., the vibration sensor or noise speaker and the input exciter are located at adjacent locations on the same noise transmission path.

In some implementations, signals f1, f2, and f3 output from the input exciters 110_1, 110_2, and 110_3, respectively, are values obtained by multiplying the input reference signals x1, x2, and x3 by updated adaptive transfer characteristic coefficients w11, w22, and w33, respectively, as shown in Equation 1.

$$\begin{matrix}f 1 = w 11 \times x 1 \\ f 2 = w 22 \times x 2 \\ f 3 = w 33 \times x 3\end{matrix} \qquad [ Equation 1 ]$$

Referring to FIG. 2, as shown in the following Equation 2, a plurality of input exciters 110_1, 110_2, and 110_3 and one or more target microphones 108_1, 108_2, and 108_3 are connected through the acoustic transfer function between the actual input point and the target indoor sound.

$$( \begin{matrix}y 1 \\ y 2 \\ y 3\end{matrix} ) = ( \begin{matrix}H 11 & H 12 & H 13 \\ H 21 & H 22 & H 23 \\ H 31 & H 32 & H 33\end{matrix} ) ( \begin{matrix}f 1 \\ f 2 \\ f 3\end{matrix} ) = ( \begin{matrix}H 11 & H 12 & H 13 \\ H 21 & H 22 & H 23 \\ H 31 & H 32 & H 33\end{matrix} ) ( \begin{matrix}w 11 & 0 & 0 \\ 0 & w 22 & 0 \\ 0 & 0 & w 33\end{matrix} ) ( \begin{matrix}x 1 \\ x 2 \\ x 3\end{matrix} ) \qquad [ Equation 2 ]$$

For example, x1, x2, and x3 can refer to reference signals respectively input to the input exciters 110_1, 110_2, and 110_3, w11, w22, and w33 can refer to adaptive transfer characteristic coefficients applied to the input exciters 110_1, 110_2, and 110_3, respectively, Hij can refer to the acoustic transfer function between an i^{th} input exciter and a j^{th} target microphone, and y1, y2, and y3 can refer to the target microphone signals (indoor sound) output from the target microphone.

From Equation 2, an output signal y1 of the target microphone 108_1 can be obtained by Equation 3 below.

$$y 1 = H 11 \times w 11 \times x 1 + H 12 \times w 22 \times x 2 + H 13 \times w 33 \times x 3 = D 1 \times x 1 + D 2 \times x 2 + D 3 \times x 3 \qquad [ equation 3 ]$$

For example, D1, D2, and D3 can refer to contributions of noise transfer paths generated by the reference signals x1, x2, and x3 in the target microphone 108_1, respectively.

From Equation 3, it can be seen that the noise transfer path contributions D1, D2, and D3 of each reference signal are determined by the product of the adaptive transfer characteristic coefficients w11, w22, and w33 applied to the input exciter 110_1, 110_2, and 110_3, respectively, and the acoustic transfer function of each input exciter and the target microphone 108_1.

As described above, the contribution analysis method for each transfer path by TPA technology requires a lot of manpower/time to calculate the input load (vibration force) and volume speed, but according to the exemplary implementation of the present disclosure, an adaptive transfer characteristic coefficient automatically updated by the ANC algorithm can be utilized, such that contribution analysis for each transfer path can be performed while reducing manpower/time.

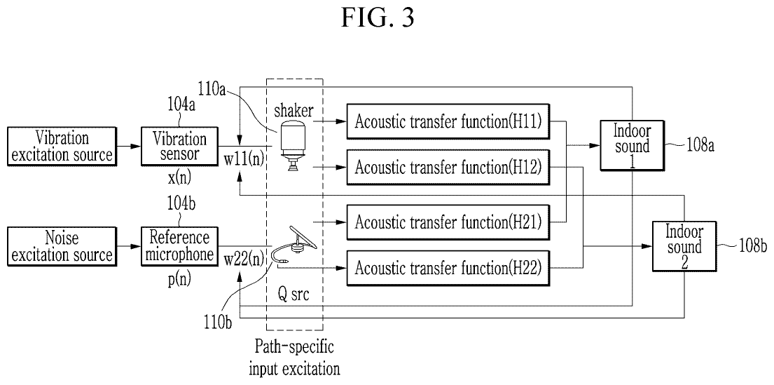

FIG. 3 is a diagram illustrating an example of the noise/vibration transfer path.

Referring to FIG. 3, a vibration excitation source and a noise excitation source can be used as causes of noise at a target position (a position of a target microphone). Examples of the vibration excitation source can include vibration between a vehicle and a road surface, vibration between components in the vehicle, and the like, and examples of the noise excitation source may be generated in various forms, such as wind noise and engine noise.

At least one vibration sensor 104a can detect a vibration excitation source and output a reference signal x(n), and at least one reference microphone 104b can detect a noise excitation source and output a reference signal p(n). The reference signal x(n) output from the vibration sensor 104a can be output from a vibration control exciter 110a by applying the updated adaptive transfer characteristic coefficient w11, and the reference signal p(n) output from the reference microphone 104b can be output from the noise control speaker 110b by applying the updated adaptive transfer characteristic coefficient w22. As such, each reference signal may not be intricately connected to an output signal, and each reference signal and an input exciter for each path can correspond one-to-one to have physical causality.

Since the noise (indoor sound 1) sensed by the target microphone 108a can be obtained by the adaptive transfer characteristic coefficient w11 applied to the vibration control exciter 110a, the acoustic transfer function H11, the adaptive transfer characteristic coefficient w22 applied to the noise control speaker 110b, and the acoustic transfer function H21, the contribution of the noise transfer path generated by each reference signal x(n) and p(n) to the noise (indoor sound 1) sensed by the target microphone 108a can be analyzed. In some implementations, the acoustic transfer function H11 can be an acoustic transfer characteristic measured in advance between the target microphone 108a and the vibration control exciter 110a, and the acoustic transfer function H21 can be an acoustic transfer characteristic measured in advance between the target microphone 108a and the noise control speaker 110b.

Similarly, since the noise (indoor sound 2) sensed by the target microphone 108b can be obtained by the adaptive transfer characteristic coefficient w11 applied to the vibration control exciter 110a, the acoustic transfer function H12, the adaptive transfer characteristic coefficient w22 applied to the noise control speaker 110b, and the acoustic transfer function H22, the contribution of the noise transfer path generated by each reference signal x(n) and p(n) to the noise (indoor sound 2) sensed by the target microphone 108b can be analyzed. In some implementations, the acoustic transfer function H12 can be an acoustic transfer characteristic measured in advance between the target microphone 108b and the exciter 110a, and the acoustic transfer function H22 can be an acoustic transfer characteristic measured in advance between the target microphone 108b and the noise control speaker 110b.

In FIG. 3, the adaptive transfer characteristic coefficient w11 applied to the vibration control exciter 110a and the adaptive transfer characteristic coefficient w22 applied to the noise control speaker 110b can be automatically updated to a value that can reduce indoor sound as much as possible by the ANC algorithm.

Therefore, according to implementations of the present disclosure, unlike the TPA method for calculating a direct physical driving load, the contribution of each noise can be analyzed through the updated adaptive transfer characteristic coefficient.

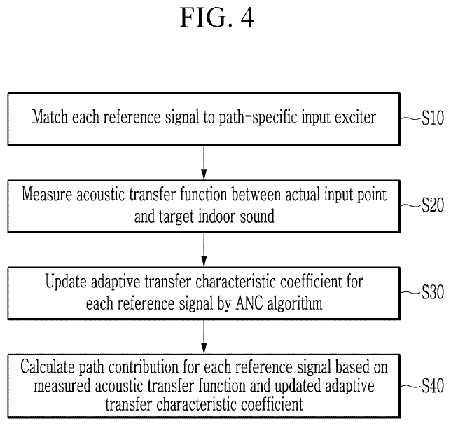

FIG. 4 is a flowchart illustrating an example of a method of analyzing a noise/vibration transfer path.

First, each reference signal and an input exciter for each path are matched one-to-one (S10). For example, as shown in FIG. 3, the reference signal x(n) output from the vibration sensor 104a corresponds to the vibration control exciter 110a, and the reference signal p(n) output from the reference microphone 104b corresponds to the noise control speaker 110b.

Thereafter, a plurality of acoustic transfer functions between the actual input point (speaker or exciter) and the target indoor sound can be measured (S20). For example, as shown in FIG. 3, an acoustic transfer function H11 between the target microphone 108a and the vibration control exciter 110a, an acoustic transfer function H21 between the target microphone 108a and the noise control speaker 110b, an acoustic transfer function H12 between the target microphone 108b and the vibration control exciter 110a, and an acoustic transfer function H22 between the target microphone 108b and the noise control speaker 110b can be measured in advance and stored in the acoustic transfer function storage unit 250.

Then, an adaptive transfer characteristic coefficient that minimizes the target indoor sound as much as possible can be updated by the ANC control algorithm for each reference signal (S30). For example, the adaptive transfer characteristic coefficient w11 and the adaptive transfer characteristic coefficient w22 that may minimize the target indoor sound 1 (the output sound of the target microphone 108a) can be updated by applying the ANC algorithm in FIG. 3.

Thereafter, the contribution of the path for each reference signal can be calculated based on the measured acoustic transfer function and the updated adaptive transfer characteristic coefficient (S40). For example, in FIG. 3, the contribution to the reference signal x(n) in the target indoor sound 1 can be obtained by using the acoustic transfer function H11 measured in operation S20 and the adaptive transfer characteristic coefficient w11 updated in operation S30, and the contribution to the reference signal p(n) in the target indoor sound 1 can be obtained by using the acoustic transfer function H21 measured in operation S20 and the adaptive transfer characteristic coefficient w22 updated in operation S30.

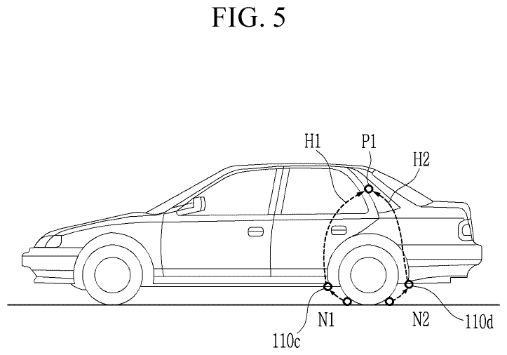

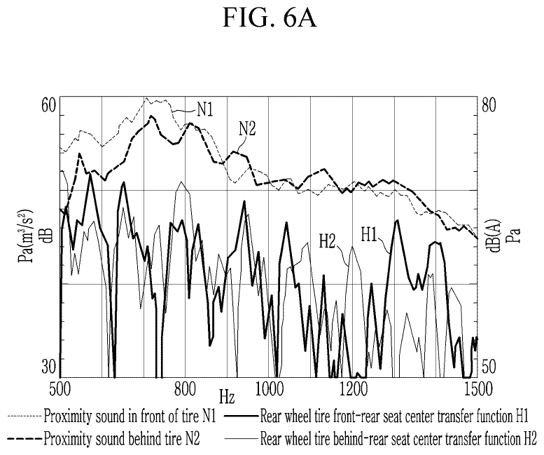

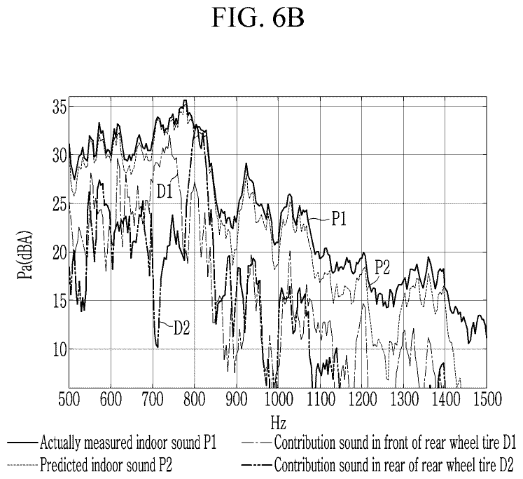

FIGS. 5 and 6 are diagrams illustrating an example of a tire emission noise transfer path analysis case to which the noise/vibration transfer path analysis method is applied.

Referring to FIG. 5, rear wheel tire front/back proximity sounds N1 and N2 can be set to analyze the degree (contribution) that affects the noise P1 near the rear seat (target microphone). In FIG. 5, a tire proximity microphone 110c disposed at a front side of the rear wheel tire can measure a radiation sound generated from the front side of the rear wheel tire, and a tire proximity microphone 110d disposed at a rear side of the rear wheel tire can measure a radiation sound generated from the rear side of the rear wheel tire.

The acoustic transfer function H1 can be an acoustic transfer characteristic between the tire proximity microphone 110c and the target microphone, and the acoustic transfer function H2 can be an acoustic transfer characteristic between the tire proximity microphone 110d and the target microphone.

FIG. 6A shows waveforms of the front/rear proximity sounds N1 and N2 and the acoustic transfer functions H1 and H2 of the rear wheel tire set in FIG. 5. FIG. 6B shows the path contribution of each reference signal (a proximity sound in front of the tire, a proximity sound in rear of the tire) derived by the noise/vibration transfer path analysis method. As depicted in FIG. 6B, the proximity sound from the front side of the rear wheel tire may exert a great influence on the noise of the rear seat.

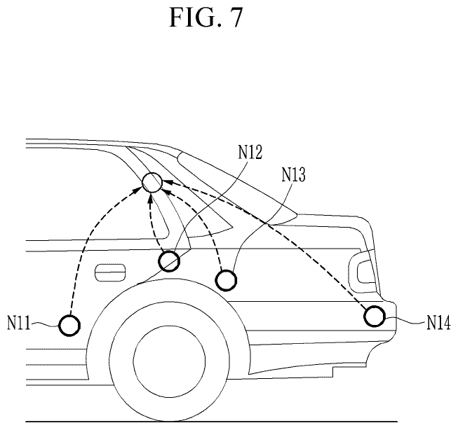

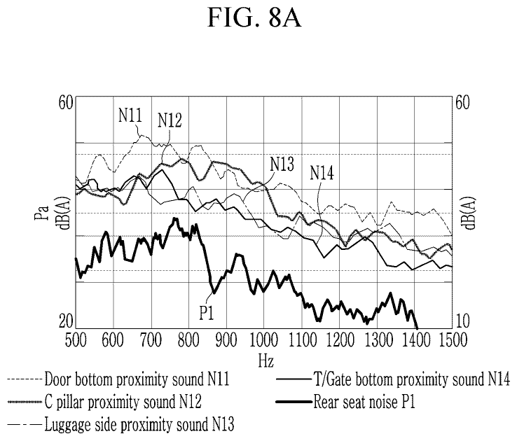

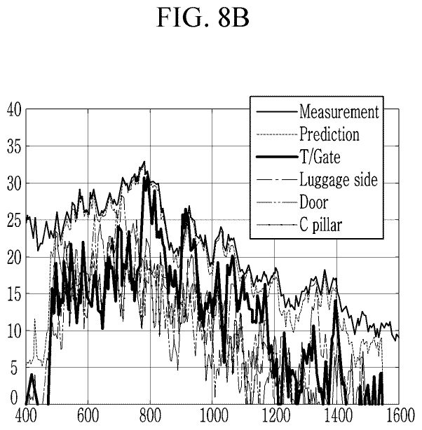

FIGS. 7, 8A, and 8B are diagrams illustrating an example of a high-frequency noise transfer path analysis of a rear seat indoor luggage to which the noise/vibration transfer path analysis method is applied.

Referring to FIG. 7, a rear seat door bottom proximity sound N11, a C-pillar proximity sound N12, a luggage side proximity sound N13, and a trunk (tail gate) bottom proximity sound N14 can be set to analyze the degree (contribution) of affecting the noise near the rear seat (target microphone). In FIG. 7, a reference microphone can be installed to measure the rear seat door bottom proximity sound N11, the C-pillar proximity sound N12, the luggage side proximity sound N13, and the trunk bottom proximity sound N14. In some implementations, the acoustic transfer function can be measured in advance between the reference microphones installed in the rear seat door bottom proximity sound N11, the C-pillar proximity sound N12, the luggage side proximity sound N13, and the trunk bottom proximity sound N14, and the target microphone, respectively.

FIG. 8A shows the rear door bottom proximity sound N11, the C-pillar proximity sound N12, the luggage side proximity sound N13, the trunk bottom proximity sound N14, and noise P1 at the target microphone set in FIG. 7.

FIG. 8B shows the path contribution for each reference signal (rear door bottom proximity sound, C pillar proximity sound, luggage side proximity sound, and trunk bottom proximity sound) derived by the noise/vibration transfer path analysis method.

Referring to FIG. 8A, since the noise P1 waveform in the target microphone and the luggage side proximity sound N13 were found to be the most similar, it may be incorrectly determined that the luggage side has the most influence on the rear seat noise when analyzing the noise/vibration transfer path only with the proximity sound for each part.

However, as shown in FIG. 8B, the results derived by the noise/vibration transfer path analysis method show that the trunk bottom proximity sound can have a greater impact on the noise of the rear seat than the luggage side proximity sound.

According to the exemplary implementations of the present disclosure, the contribution of the noise transfer path can be efficiently analyzed by connecting the transfer path input signal to the input exciter one-to-one to match the noise/vibration transfer path, and then recognizing the main transfer path through the noise or vibration generated by the noise/vibration source and transmitted through various paths through the active noise removal (ANC) algorithm.

In addition, according to the exemplary implementations of the present disclosure, it is possible to analyze not only the transfer path of the existing excitation source unit but also the noise contribution analysis at a predetermined point on the noise/vibration transfer path.

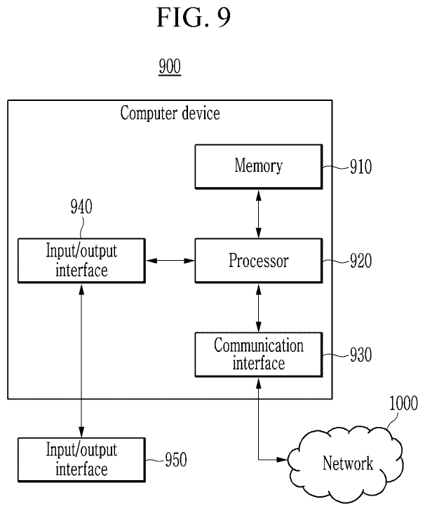

FIG. 9 is a diagram illustrating an example of a computer device. The path contribution analysis unit 240 for each path described in FIG. 1 can be implemented by a computer device 900 shown in FIG. 9.

As illustrated in FIG. 9, the computer device 900 can include a memory 910, a processor 920, a communication interface 930, and an input/output interface 940. The memory 910 can be a computer-readable recording medium, which can include random access memory (RAM), read only memory (ROM), and a non-transitory permanent mass storage device such as a disk drive. Additionally, the memory 910 can store an operating system and at least one program code. These software components can be loaded into the memory 910 from a computer-readable recording medium that is separate from the memory 910. The separate computer-readable recording medium can include a computer-readable recording medium, such as a hard disk, flash memory, optical disk, external hard disk, or the like. Additionally, these software components can be loaded into the memory 910 via the communication interface 930.

The processor 920 can be configured to process instructions from a computer program by performing basic arithmetic, logic, and input/output operations. The instructions can be provided to the processor 920 by the memory 910 or by the communication interface 930.

The communication interface 930 can provide functionality for the computer device 900 to communicate with other devices and with each other over the network 1000.

The input/output interface 940 can refer to an interface with the input/output device 950. For example, the input device can include a device, such as a microphone, a keyboard, or a mouse, and an output device can include a device, such as a display or a speaker.

The exemplary implementations described above can be provided in the form of computer programs that can be executable by various components on a computer, and such programs can be recorded on a computer-readable medium. The medium can include magnetic media such as hard disks, floppy disks, and magnetic tapes, optical recording media such as CD-ROMs and DVDs, magneto-optical media such as floptical disks, and hardware devices specifically configured to store and execute program instructions, such as ROM, RAM, flash memory, and the like.

What is claimed is:

1. A noise/vibration transfer path analysis apparatus for analyzing contribution of a transfer path of noise/vibration in a vehicle comprising a plurality of sensors, a plurality of input exciters, and a target microphone, the noise/vibration transfer path analysis apparatus comprising:
an acoustic transfer function storage configured to store a plurality of acoustic transfer functions including (i) a first acoustic transfer function between a first input exciter of the plurality of input exciters and the target microphone and (ii) a second acoustic transfer function between a second input exciter of the plurality of input exciters and the target microphone;
an adaptive filter configured to:
generate a first noise prevention signal based on a first reference signal output from a first sensor of the plurality of sensors and a first adaptive transfer characteristic coefficient,
output the generated first noise prevention signal to the first input exciter,
generate a second noise prevention signal based on a second reference signal output from a second sensor of the plurality of sensors and a second adaptive transfer characteristic coefficient, and
output the generated second noise prevention signal to the second input exciter;
an adaptive filter controller configured to update the first and second adaptive transfer characteristic coefficients based on an error signal output from the target microphone; and
a path contribution analysis unit, implemented using one or more computing devices, configured to, based on the updated first and second adaptive filter coefficients and the first and second acoustic transfer functions stored in the acoustic transfer function storage, analyze contribution of a noise transfer path in the target microphone for each of the first and second reference signals.

2. The noise/vibration transfer path analysis apparatus of claim 1, wherein:
the first sensor is a vibration sensor or a reference microphone.

3. The noise/vibration transfer path analysis apparatus of claim 1, further comprising:
a path filter configured to filter (i) the first reference signal with a modeled first acoustic transfer function corresponding to the first acoustic transfer function and (ii) the second reference signal with a modeled second acoustic transfer function corresponding to the second acoustic transfer function.

4. The noise/vibration transfer path analysis apparatus of claim 3, wherein:
the adaptive filter controller is configured to update the first and second adaptive transfer characteristic coefficients in a direction that reduces a size of the error signal based on the first reference signal filtered by the modeled first acoustic transfer function, the second reference signal filtered by the modeled second acoustic transfer function, and the error signal.

5. The noise/vibration transfer path analysis apparatus of claim 1, wherein:
the first sensor and the second sensor match one-to-one the first input exciter and the second input exciter, respectively, and
the contribution of the noise transfer path in the target microphone generated by the first reference signal is determined based on a product of the first adaptive filter coefficient and the first acoustic transfer function, and
the contribution of the noise transfer path in the target microphone generated by the second reference signal is determined based on a product of the second adaptive filter coefficient and the second acoustic transfer function.

6. A noise/vibration transfer path analysis method for analyzing contribution of a transfer path of noise or vibration in a vehicle comprising a plurality of sensors, a plurality of input exciters, and a target microphone, the noise/vibration transfer path analysis method comprising:
associating a first reference signal output from a first sensor of the plurality of sensors with a first input exciter of the plurality of input exciters, and a second reference signal output from a second sensor of the plurality of sensors to a second input exciter of the plurality of exciters;
measuring and storing a plurality of acoustic transfer functions including a first acoustic transfer function between the first input exciter and the target microphone and a second acoustic transfer function between the second input exciter and the target microphone;
updating first and second adaptive transfer characteristics coefficients applied to the first and second input exciters respectively with an active noise removal (ANC) algorithm; and
analyzing, based on the updated first and second adaptive filter coefficients and the stored first and second acoustic transfer functions, contribution of a noise transfer path in the target microphone for each of the first and second reference signals.

7. The noise/vibration transfer path analysis method of claim 6, wherein updating first and second adaptive transfer characteristics coefficients comprises:
generating a first noise prevention signal based on a first reference signal output from the first sensor and the first adaptive transfer characteristic coefficient and outputting the generated first noise prevention signal to the first input exciter;
generating a second noise prevention signal based on a second reference signal output from the second sensor and the second adaptive transfer characteristic coefficient and outputting the generated second noise prevention signal to the second input exciter; and
updating the first and second adaptive transfer characteristic coefficients based on an error signal output from the target microphone.

8. The noise/vibration transfer path analysis method of claim 7, wherein updating first and second adaptive transfer characteristics coefficients comprises:
filtering the first reference signal with a modeled first acoustic transfer function corresponding to the first acoustic transfer function; and
filtering the second reference signal with a modeled second acoustic transfer function corresponding to the second acoustic transfer function.

9. The noise/vibration transfer path analysis method of claim 8, wherein updating first and second adaptive transfer characteristics coefficients comprises:
updating the first and second adaptive transfer characteristic coefficients in a direction that minimizes a size of the error signal based on a first reference signal filtered by the modeled first acoustic transfer function, a second reference signal filtered by the modeled second acoustic transfer function, and the error signal.

10. A computer comprising:
at least one memory storing instructions; and
at least one processor configured to execute the instructions to perform operations comprising:
storing a plurality of acoustic transfer functions including a first acoustic transfer function between a first input exciter and a target microphone provided in a vehicle, and a second acoustic transfer function between a second input exciter provided in the vehicle and the target microphone,
updating first and second adaptive transfer characteristics coefficients applied to the first and second input exciters respectively with an active noise removal (ANC) algorithm, and
analyzing, based on the updated first and second adaptive filter coefficients and the stored first and second acoustic transfer functions, contribution of a noise transfer path in the target microphone for each of first and second reference signals, the first and second reference signals being respectively output from first and second sensors provided in the vehicle.

11. The computer of claim 10, wherein updating first and second adaptive transfer characteristics coefficients comprises:
generating a first noise prevention signal based on the first reference signal and the first adaptive transfer characteristic coefficient, and outputting the generated first noise prevention signal to the first input exciter,
generating a second noise prevention signal based on the second reference signal and the second adaptive transfer characteristic coefficient, and outputting the generated second noise prevention signal to the second input exciter, and
updating the first and second adaptive transfer characteristic coefficients based on an error signal output from the target microphone.

12. The computer of claim 11, wherein:
the first and second adaptive transfer characteristic coefficients are updated by a filtered-x least mean square algorithm.
